(19) United States
(12) Patent Application Publication
(10) Pub. No.: US 2010/0029155 A1
(43) Pub. Date: Feb. 4, 2010

(54) Adhesive coated fabrics suitable for use in composite materials

(75) Inventors: Charles William Peterson, Bernin (GB); Martin William John Spooner, Hampshire (GB); Lee Ian, Goodworth Clatford (GB)

Correspondence Address: OWENS CORNING, 2790 COLUMBUS ROAD, GRANVILLE, OH, 43023, US

(73) Assignee: SAINT-GOBAIN SYNOOGIAS N.V.

(21) Appl. No.: 12/067,638

(22) PCT Filed: Sep. 22, 2005
(86) PCT No.: PCT/EP2005/010371

§ 371 Date: Jul. 14, 2009

(51) Int. Cl. B32B 27/04; B05D 5/10

(52) U.S. Cl. 442/79; 442/149; 427/207.1

(57) ABSTRACT

The present invention relates to adhesive coated fabrics, suitable for use in composite materials, coated on at least one outwards facing surface thereof with an acrylate adhesive, wherein the coated acrylate adhesive on said at least one outwards facing surface is less than 11 g/m² solid particles. Such adhesive coated fabrics are especially useful for the manufacturing of water or moist resistant or repellant structures such as boats, airplane components, wind turbine blades, helmets, or telephone poles.

The present invention relates to adhesive coated fabrics, to methods for the manufacturing of these adhesive coated fabrics, to composite materials comprising the adhesive coated fabrics and to the use of these adhesive coated fabrics for the manufacturing of water resistant or repellant structures.

Composite materials or assembled multilayer structures are applied in the production of for instance boats, aircraft components, cars, junction boxes, bathtubs, telephone poles, tubes, profiles and so on. Owing to their mechanical strength, their relatively light weight, their ability to be moulded, their stiffness and resistance to for instance corrosion, composite materials represent an attractive alternative to for instance metal, stone or wood.

The layers from which a composite material is constructed can be individual single layers of glass, carbon, aramid, polymeric fibers and/or other materials depending on the desired application or already (partially) preassembled individual layers of these materials. Both the single individual layers and the (partially) preassembled individual layers forming the composite material are designated herein as fabrics, thus according to the present invention a fabric is a material to be used for the manufacturing of composite materials.

The layers in a composite material, being either the above individual layers and/or the (partially) preassembled individual layers, can be subdivided into for instance fabrics which are intended to strengthen or reinforce a composite material such as strengthening layers, layers intended to provide a composite with the desired thickness or the desired volume, such as thickness-providing layers, and other layers such as covering layers, for instance for an improved protection, wear resistance, surface structure and so on, and/or finishing layers, such as for instance a paint layer or antistatic layer. A number of the above-mentioned functions may also be combined in one layer, such as for instance a strengthening layer which also serves to prevent or reduce wear.

A typical production method for providing a composite material comprises arranging the fabrics forming the composite material such as the above individual layers and/or the (partially) preassembled individual layers in a mould and subsequent moulding thereof by applying for instance a pressure or a vacuum. The composite material is obtained by impregnating the thus formed multilayered structure with a resin, such as for instance polyester resins, and the subsequent curing of the resin impregnated composite material.

During arranging of the fabrics forming the composite material in the mould, it is desirable that once placed in the mould, the fabrics maintain the same position in relation to each other and/or to the mould itself. In other words, it is desirable that the fabrics do not move after being placed in the mould.

Further, it is desirable that the operator, arranging the fabrics in the mould, is able to change the position of the fabrics after being positioned in the mould, for example if an error has been made. In other words, it is desirable that after being positioned in the mould, the fabrics can still be moved to a different position relative to the mould itself or to the other composite material forming layers in the mould.

For this, the fabric can be provided with at least one adhesive surface either for adhesion of the fabric to the mould or the adhesion of the fabric to the other composite forming layers.

However, as stated above, such adhesive surface has to meet two rather opposite criteria, first the adhesive should be strong enough to provide sufficient adhesion of the fabric to the mould surface or the other composite material forming layers and second, the adhesion must not be that strong that the fabric, once being placed, can not be moved anymore in relation to the mould or the other composite material forming layers.

In addition, a too strong adhesive will be more difficult to handle during fabric manufacturing, storing, and handling and when preparing the fabric for placing in the mould.

For example, during manufacturing, the adhesive or sticky surface of the fabric can cause undesirable adherence of the fabric to itself or to other materials present which can also be the case during storage and the subsequent handling for example during placement of the fabric in the mould. If in those cases the tackiness of the surface of the fabric is too strong, it will be very difficult, if not impossible, to make proper use of the fabric because the fabric will be damaged during removal and repositioning.

Furthermore, regarding the adhesive, it is important to note that the adhesive used will usually become part of the final composite material influencing for example its mechanical properties and its endurance against the environment in which the composite material is used such as water, moist air, salty air, or temperature. Therefore, it is important that the adhesive used will not cause an unacceptable negative influence on the desired properties of the composite material.

Also the chemical stability of the adhesive is important, especially in those cases wherein the adhesive is used for at least partially connecting the fabric to the other composite forming layers such as foam layers, honeycombs and other thickness providing layers of the composite material. In time, gradual degradation of the adhesive can result in a significant reduction or complete elimination of the structural integrity of the composite material. Especially if the composite material is used for example for constructing the hull of boats or the turbine blades such degradation is not acceptable.

Therefore, it is an object of the present invention to provide an adhesive coated fabric which addresses the above problems thereby reducing or completely eliminating at least some them.

According to the present invention, this objective is met by providing an adhesive coated fabric coated on at least one outwards facing surface thereof with an acrylate adhesive, wherein the coated dispersable acrylate adhesive on said at least one surface is less than 11 g/m² solid particles.

Acrylate adhesives provide excellent environmental resistance and fast-setting times when compared to other adhesive systems. They are created by polymerizing acrylic acids usually through a reaction with a suitable catalyst. An example of such acrylate adhesive is sold under the tradename 3M Fastbond 49 by the 3M company.

Using these acrylate adhesives coated on the fabric in an amount of less than 11 g/m² provides the desired balance between sufficient adhesion of the fabric to the mould or the other composite material forming layers and an adhesion sufficient to allow repositioning of the fabric.

The adhesive coated fabric according to the present invention also provides good handling characteristics during for example transport and storage, allowing rolling up the material and unrolling it without the requirement of the use of a separator layer in between.

Also in the final composite material, the adhesive coated fabrics according to the present invention do not cause an unacceptable negative influence on the desired properties such as the flexural strength, the flexural modulus and the fracture toughness as compared to other adhesives.

In a preferred embodiment of the present invention, the coated acrylate adhesive is less than 7 g/m² solid particles, more preferably less than 5 g/m² solid particles.

According to the present invention the surface of the fabric of the adhesive coated fabrics according to the present invention is preferably selected from the group consisting of glass fiber; aramide; carbon fibre; polymeric fibre; and combinations thereof.

Preferred embodiments of glass fiber surfaces are continuous glass fiber mats and non-woven continuous glass fiber mats.

Preferably, the adhesive coated fabrics according to the present invention comprise at least one thickness-providing layer of a non-woven or a knit of glass fibre and at least one strengthening layer connected thereto, such as for example the fabric which is described in the European patent No 0 873 441.

The adhesive coated fabrics according to the present invention can be obtained by a method comprising spraying less than 11 g/m² solid particles of an acrylate adhesive on at least one outwards facing surface of the fabric, preferably less than 7 g/m² and more preferably 5 g/m².

Composite materials can be obtained by impregnating the multi-layered structure comprising the adhesive coated fabrics according to the present invention with a resin such as a polyester resin.

The resulting composite material provides an excellent resistance against water and moisture. Therefore, the present invention also relates to the use of the adhesive coated fabrics according to the present invention for the manufacture of water resistant or repellant composite structures such as boats, wind mills, aircraft components, helmets, telephone poles, etc.

The present invention will be further described using the following example which is provided to demonstrate the advantageous properties of the adhesive coated fabrics according to the present invention but not to limit the scope of the present invention which is determined by the appended claims.

### EXAMPLE

A series of experimental materials were made by combining E-glass fibre multiaxial fabrics coated with various adhesives.

### Introduction

The adhesive coated fabrics were tested for tackiness using a loop tack test. All fabrics were infused and impregnated with a thermosetting polyester resin. Once cured, the materials were tested for mechanical properties and surface appearance changes during exposure to warm water vapour over a prolonged period of time.

### Experimental Methods

Test methods: the materials were tested according to the following standards:
ISO 14125 2001: Fibre-reinforced plastic composites—Determination of flexural properties
ISO 179/2fn 1998: Determination of Charpy impact properties—Part 2: Instrumented impact test
DIN 535300 1981: Separation test on fabric plies bonded together
Internal test: QCT Osmosis test procedure—1200 hrs single sided water vapour exposure at 60° C.

### Roll Up Test

The material SF016 (Saint-Gobian Technical Fabrics type EBX936) was coated with the acrylate adhesive 3M Fastbond 49 and did not require a release paper and unrolling was performed without distorting or damaging the adhesive coated glass fibre fabric material. All other adhesive coated fabrics tested such as Saertex-Saerfix VF 90-104-01210-01270-000 000 and styrene-isoprene-styrene hot-melt adhesive HB Fuller Lunamelt PS4015C coated fabrics required the use of backing paper to allow the fabric to unroll easily.

### Warm Water Vapour Ageing Test

The glass fibre fabrics were infused and impregnated with the following thermosetting polyester resins.

### Surface Coat Against Glass Plate Mould

Thickness: 0.5-1.0 mm
Gel coat resin: Scott Bader Crystic 65PA clear gel coat dosage 88.2% by weight
Gel coat catalyst: Akzo-Nobel M50 MEKP dosage 2% by weight
Colour pigment: Scott Bader Oxford blue dosage 9.2% by weight
   Curing conditions were 2-3 hours, temperature 18-25° C.

### Vacuum Infusion Matrix

Isopthalic unsaturated polyester resin Scott Bader Crystic 701PA dosage 99% by weight; Catalyst Akzo-Nobel M50 MEKP dosage 1% by weight and curing conditions 24 hours, ambient temperature 18-25° C.

### Structure of the Composite Material Assembled On A Release Agent Treated Glass Plate

1) gel coat

2) adhesive coated fabric (adhesion layer facing the gel coat; fibre orientation +/−45°)^{•}

3) adhesive coated fabric (adhesion layer facing fabric 2; fibre orientation −/+45°)

4) adhesive coated fabric (adhesion layer facing fabric 3; fibre orientation +/−45°)^{•}

5) adhesive coated fabric (adhesion layer facing fabric 4; fibre orientation −/+45°)

### Vacuum Infusion

The material was covered and sealed using an impervious polymer vacuum membrane and a vacuum of 0.7 bar applied for a period of 4 hours to allow for complete infusion of the composite material.

### Mechanical Property Testing

The adhesive coated glass fibre fabrics were infused and impregnated with the following thermosetting polyester resin (the materials were moulded on a glass plate mould treated with a release agent):

### Vacuum Infusion Matrix

Resin: Isopthalic unsaturated polyester resin Scott Bader Crystic 701PA, dosage 99% by weight
catalyst: Akzo-Nobel M50 MEKP, dosage 1% by weight
Curing conditions: 24 hours, ambient temperature 18 to 25° C.
Adhesive quantity: 18.25 to 11 g/m²
Adhesive type: 3M Fastbond49 (spray application)
Application: single sided deposition on the glass fiber fabrics SF014 (Saint-Gobain Technical Fabrics type EBXM936/100) and SF016 (Saint-Gobain Technical Fabrics type EBX936)

### Structure of the Composite Material Assembled On A Release Agent Treated Glass Plate

1) adhesive coated fabric (adhesion layer facing the glass plate; fibre orientation +/−45°)^{•}

2) adhesive coated fabric (adhesion layer facing fabric 1; fibre orientation −/+45°)

3) adhesive coated fabric (adhesion layer facing fabric 2; fibre orientation +/−45°)^{•}

4) adhesive coated fabric (adhesion layer facing fabric 3; fibre orientation −/+45°)

### Vacuum Infusion

The material was covered and sealed using an impervious polymer vacuum membrane and a vacuum of 0.7 bar applied for a period of 4 hours to allow for complete infusion of the composite material.

### Results

### The Water Vapour Ageing Test

The composite with the adhesive coated fabric Saertex-Saerfix VF 90104-01210-01270-000 000 showed >500 between 2 and 4 mm diameter blisters in a regular dot pattern. The acrylate adhesive coated fabric according to the present invention showed <100 between 2 and 4 mm diameter blisters in a random pattern. This demonstrates the increased water resistance of the adhesive coated fabrics according to the present invention.

### The Mechanical Property Tests

### Flexural Strength

Test sample I (3M Fastbond 49 adhesive): 598 MPa
Test sample II (Styrene-Isoprene-Styrene hot-melt adhesive HB Fuller Lunamelt PS4015C): 492 MPa

### Flexural Modulus

Test sample I (3M Fastbond 49 adhesive) 22846 MPa
Test sample II ((Styrene-Isoprene-Styrene hot-melt adhesive HB Fuller Lunamelt PS4015C): 18978 MPa

### Fracture Toughness

Test sample I (3M Fastbond 49 adhesive) 202 kJ/m2
Test sample II ((Styrene-Isoprene-Styrene hot-melt adhesive HB Fuller Lunamelt PS4015C): 198 kJ/m²
   The glass fibre contents were typically 74% by weight of the final composite material.

These results demonstrate the improved mechanical properties of a composite comprising the acrylate adhesive coated fabrics according to the present invention.

1. Adhesive coated fabric, suitable for use in composite materials, coated on at least one outwards facing surface thereof with an acrylate adhesive, wherein the coated acrylate adhesive on said at least one outwards facing surface is less than 11 g/m² solid particles.

2. Adhesive coated fabric according to claim 1, wherein the coated acrylate adhesive on said at least one outwards facing surface is less than 7 g/m² solid particles.

3. Adhesive coated fabric according to claim 1 or claim 2, wherein the coated acrylate adhesive on said at least one outwards facing surface is less than 5 g/m² solid particles.

4. Adhesive coated fabric according to any of the claims 1 to 3, wherein the outwards facing surface is selected from the group consisting of glass fiber, aramide, carbon fibre, polymeric fibre, and combinations thereof.

5. Adhesive coated fabric according to any of the claims 1 to 4, wherein the outwards facing surface is a continuous glass fiber mat.

6. Adhesive coated fabric according to any of the claims 1 to 5, wherein the outwards facing surface is a nonwoven continuous glass fiber mat.

7. Adhesive coated fabric according to any of the claims 1 to 6, wherein the adhesive coated fabric comprises at least one thickness-providing layer of a non-woven or a knit of glass fibre and at least one strengthening layer connected thereto.

8. Method for preparing an adhesive coated fabric, wherein the method comprises spraying less than 11 g/m² solid particles of an acrylate adhesive on at least one outwards facing surface of the fabric.

9. Method according claim 8, wherein less than 7 g/m² solid particles of an acrylate adhesive is sprayed on the at least one outwards facing surface of the fabric.

10. Method according claim 8 or claim 9, wherein less than 5 g/m² solid particles of an acrylate adhesive is sprayed on the at least one outwards facing surface of the fabric.

11. Adhesive coated fabric obtainable by using a method according to any of the claims 8 to 10.

12. Composite material comprising an impregnated adhesive coated fabric according to any of the claims 1 to 7 or claim 11.

13. Use of an adhesive coated fabric according to any of the claims 1 to 7, the adhesive coated fabric according to claim 11, or the composite material according to claim 12 for the manufacture of water resistant or repellant structures.
